(19) United States
(12) Patent Application Publication
(10) Pub. No.: US 2025/0329831 A1
(43) Pub. Date: Oct. 23, 2025

(54) INTERLAYER DESIGN FOR SOLID STATE ELECTROCHEMICAL CELLS AND ELECTROCHEMICAL CELL MADE THEREOF

(71) Applicant: Solid Power Operating, Inc., Louisville, CO (US)

(72) Inventors: Andrew YEANG, Boulder, CO (US); Alexandra BOTHWELL, Boulder, CO (US); Rose E. RUTHER, Lafayette, CO (US); Levi SCHUTT, Denver, CO (US); Parker SCHOFIELD, Westminster, CO (US); Ian A. MORRISSEY, Boulder, CO (US)

(21) Appl. No.: 19/187,900

(22) Filed: Apr. 23, 2025

Related U.S. Application Data
(60) Provisional application No. 63/637,811, filed on Apr. 23, 2024.

(51) Int. Cl. H01M 50/122; H01M 10/058; H01M 50/119; H01M 50/124

(52) U.S. Cl. CPC H01M 50/122; H01M 10/058; H01M 50/119; H01M 50/124

(57) ABSTRACT

Solid-state electrochemical cells include a first current collector, an interlayer, a separator layer, a cathode layer, and a second current collector. The interlayer includes a metal and a mix of carbon materials. When the electrochemical cell is charged, the interlayer splits into a top layer and a bottom layer and a layer of lithium metal forms between the top layer and the bottom layer.

### CROSS-REFERENCE TO RELATED APPLICATION

This application is related to and claims priority under 35 U.S.C. § 119(e) from U.S. Patent Application No. 63/637,811, filed Apr. 23, 2024, titled “Interlayer Design for Solid State Electrochemical Cells and Electrochemical Cell Made Thereof,” the entire contents of which is incorporated herein by reference for all purposes.

### TECHNICAL FIELD

The present disclosure is related to solid-state electrochemical cells that include an interlayer and methods for making the same.

### Background and Introduction

With the advancements made in battery technology, the ability to electrify vehicles has reached an all-time high. However, conventional batteries do not have the energy density needed to power other mobile systems such as drones or airplanes. To make this technological leap, the anode of the battery, which is normally a thick layer of carbon, is replaced with a very thin layer of a lithium wetting material. This replacement allows for the volume and weight of the battery to be reduced while maintaining a similar energy output. This results in an increase in the energy density and volume density of these batteries to the point where they can be used to power mobile systems such as drones.

While replacing the anode material with this new designed interlayer increases the energy density of the battery, they currently suffer from high pressure requirements (the battery needs to be maintained under pressure while cycling) and short cycle life. These negative attributes of the design stem from how the current interlayer systems operate. The current interlayer design allows for lithium ions to fully diffuse though the interlayer where the lithium collects as lithium metal at the interface between the interlayer and the current collector. When the lithium is pulled back into the cathode during the discharge process of the battery, a gap is formed between the current collector and interlayer. This gap drastically reduces the physical contacts between the two layers increasing electronic resistance and decreasing battery life. To overcome these issues, the battery should be compressed at very high pressure to form the two layers back together. The need to incorporate equipment to supply this pressure ultimately negates any energy density benefits gained to using the interlayer designs of today.

It is with these observations in mind, among others, that aspects of the present disclosure were conceived.

### SUMMARY

Provided herein are electrochemical cells comprising a first current collector layer; an interlayer comprising a mixture of carbon materials, a metal, and a binder; a separator layer, wherein the interlayer is positioned between the first current collector layer and the separator layer; a cathode layer; and a second current collector layer. In some embodiments, the metal is selected from the group consisting of silver, zinc, aluminum, magnesium, tin, antimony, silicon, and any combination thereof. In some embodiments, the metal has an average particle size of less than about 10 μm. In some embodiments, the metal comprises silicon. In some embodiments, the metal has a concentration in the interlayer from about 1 wt % to about 50 wt %. In some embodiments, wherein the silicon has a concentration in the interlayer from about 5 wt % to about 50 wt %. In some embodiments, the mixture of carbon materials comprises graphite and carbon black. In some embodiments, the interlayer is coated at a loading from about 0.1 and about 2 mg/cm². In some embodiments, the interlayer has a thickness from about 2 μm to about 20 μm. In some embodiments, the interlayer has a density from about 0.5 g/cm³ to about 2 g/cm³. In some embodiments, the interlayer has a porosity from about 10% to about 50%.

Further provided herein are electrochemical cells comprising a first current collector layer; a top interlayer comprising a mixture of carbon materials, a metal, and a binder; a lithium metal layer; a bottom interlayer comprising a mixture of carbon materials, a metal, and a binder, wherein the lithium metal layer is disposed between the top interlayer and the bottom interlayer; a separator layer; a cathode layer; and a second current collector layer. In some embodiments, the lithium metal layer consists of lithium metal. In some embodiments, the lithium metal layer comprises lithium metal and a metal selected from the group consisting of silver, zinc, aluminum, magnesium, tin, antimony, silicon, and any combination thereof. In some embodiments, the metal of the top layer and the bottom layer comprises silicon. In some embodiments, the metal of the top layer has a concentration in the top layer from about 1 wt % to about 50 wt %. In some embodiments, the mixture of carbon materials comprises graphite and carbon black. In some embodiments, the metal of the top layer and the metal of the bottom layer are the same.

Further provided herein are methods for making electrochemical cells. The methods include coating an interlayer composition onto a first current collector, thereby forming a first portion of the electrochemical cell; coating a cathode layer composition onto a second current collector; coating a separator layer composition onto the cathode layer composition, thereby forming a second portion of the electrochemical cell; and laminating the first portion of the electrochemical cell with the second portion of the electrochemical cell.

The Inventors have invented an interlayer that allows for lithium metal to accumulate internally in the interlayer. This splits the interlayer but maintains the robust interface between the interlayer and the current collector and the interface between the current collector and the solid electrolyte layer. This interlayer design allows for an increased energy density of the battery while allowing for low pressure applications.

### BRIEF DESCRIPTION OF THE DRAWINGS

The present disclosure may be understood by reference to the following detailed description taken in conjunction with the drawings briefly described below. It is noted that, for purposes of illustrative clarity, certain elements in the drawings may not be drawn to scale.

FIG. 1 shows a diagram of a solid-state electrochemical design including an interlayer as described herein.

FIG. 2 shows a schematic describing the lithiation behavior of a solid-state electrochemical cell including an interlayer as described herein.

FIG. 3 shows a set of Scanning Electron Microscope (SEM) images of the electrochemical cell of Example 1. The top image shows the interlayer as-built, the middle image shows the interlayer after the electrochemical cell was fully charged, and the bottom image shows the interlayer after the electrochemical cell was fully discharged.

### DETAILED DESCRIPTION

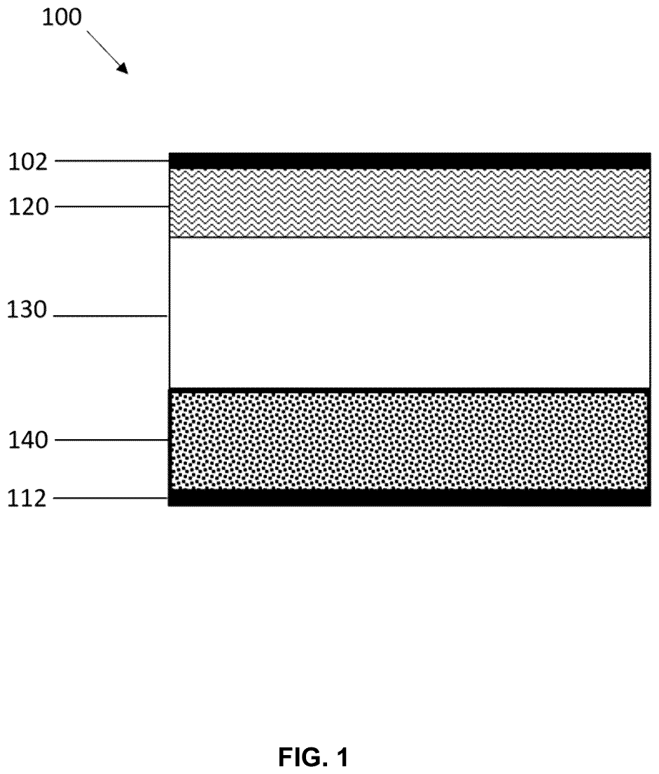

Referring now to FIG. 1, the electrochemical cell 100 of the present disclosure may comprise a first current collector layer 102, an interlayer 120, a separator layer 130, a cathode layer 140, and a second current collector layer 112.

In a traditional anode (i.e. graphite, silicon), lithium ions react with the anode active material by way of intercalation and/or alloying to store charge. The reverse reaction occurs during discharge. In these anodes, electroplated lithium during charge is an undesired reaction as lithium typically plates in a “dendritic” morphology, instead of reacting by intercalation and/or alloying. Further, these lithium dendrites are very difficult to strip off entirely during the subsequent discharge step. The dendrites serve as nucleation sites for further lithium metal plating on subsequent cycles, taking away active lithium inventory and causing contact loss between the anode and separator. If this process proceeds long enough, the dendrite will grow across to the cathode and form a short circuit.

Lithium metal may also be used as an anode, which has the highest theoretical energy density of an anode material. In these anodes, plating and stripping of lithium is desired. Lithium eventually will plate in a dendritic morphology, leading to the cell failure described above. The lithium metal from the original anode build can serve as a reservoir to make up for any lost inventory. This is not always the case as contact loss between the bulk of the lithium anode and separator can occur as dendrites are formed and grow. While thicker lithium metal anodes can help extend cycle life, thicker lithium increases cost and further reduces energy density of the cell. Finally, because of lithium metal's very low reduction potential, it is also reactive in contact with many electrolyte/separator chemistries.

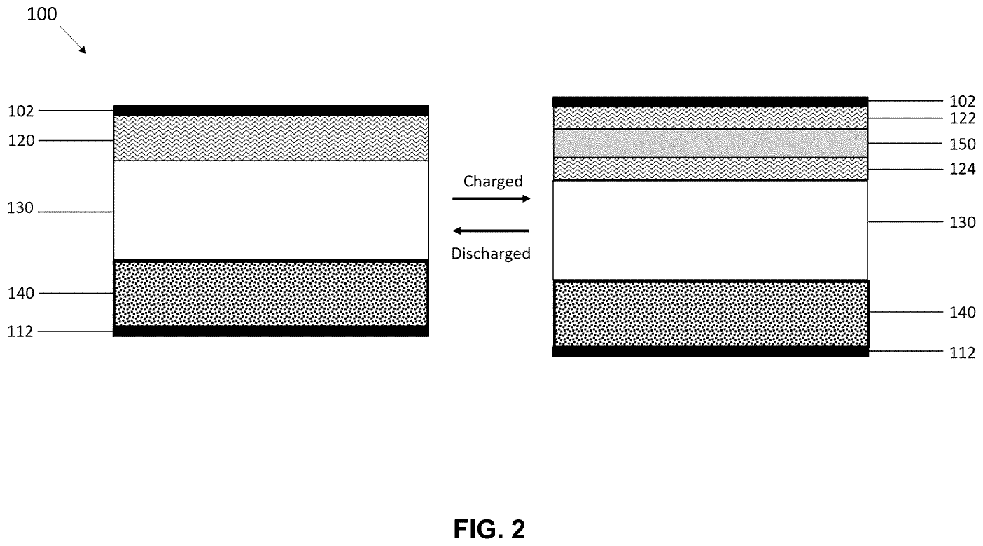

As shown in FIG. 2, when the electrochemical cell 100 containing the interlayer 120 is charged, lithium ions move from the cathode layer 140, through the separator layer 130, and start to collect in the interlayer 120. Prior to charging, the interlayer 120 may be free of lithium. As the lithium ions continue to collect in the interlayer 120, they collect and form a lithium metal layer 150, and splits the interlayer into a top layer 122 and a bottom layer 124. When the electrochemical cell 100 is discharged, the lithium metal layer 150 is converted back into lithium ion and moves back into the cathode layer 140. At this point, the top layer 122 and bottom layer 124 of the interlayer 120 rejoin. The top layer 122 and the bottom layer 124 each comprise the same materials as the interlayer 120.

By using an electrochemical cell 100 having an interlayer 120 as described herein, lithium metal is plated between the interlayer 120 and the first current collector 102 upon charge. The interlayer 120 may act as a physical barrier between the lithium metal layer 150 and the separator layer 130. Upon stripping, the lithium metal layer 150 should be oxidized and the contact between the first current collector 102, interlayer 120, and separator layer 130 is restored.

Returning to FIG. 1, the interlayer 120 is positioned between the separator layer 130 and the first current collector layer 102. The interlayer 120 may be operably coupled with the first current collector layer 102. The cathode layer 140 may be operably coupled with the separator layer 130, and the separator layer 130 is positioned between the interlayer 120 and the cathode layer 140. The second current collector layer 112 may be operably coupled with the cathode layer 140.

The first current collector layer 102 may include copper, aluminum, nickel, titanium, stainless steel, magnesium, iron, zinc, indium, germanium, silver, platinum, gold, or any combination thereof.

The interlayer 120 is in operable contact with the first current collector layer 102, and may be in physical contact with the first current collector layer 102. The interlayer 120 may comprise a mixture of carbon materials. The mixture of carbon materials may include amorphous carbon, carbon black (C65), conducting graphite (e.g., SK6), and other forms of carbon.

The interlayer 120 may further comprise a metal selected from the group consisting of silver, zinc, aluminum, magnesium, tin, antimony, silicon, and any combination thereof. The metal may be present in the interlayer 120 in an amount from about 1 wt % to about 60 wt %. Without wishing to be bound by theory, it is believed that the carbon mixture facilitates conduction of electrons through the layer while at the start of charge, the metal alloys with lithium. This alloying promotes a more uniform lithium metal plating behavior at the end of a charging protocol.

The metal may be present in the interlayer 120 in an amount from about 1 wt % to about 60 wt %, such as from about 1 wt % to about 10 wt %, about 1 wt % to about 20 wt %, about 1 wt % to about 30 wt %, about 1 wt % to about 40 wt %, about 1 wt % to about 50 wt %, about 1 wt % to about 60 wt %, about 10 wt % to about 60 wt %, about 20 wt % to about 60 wt %, about 30 wt % to about 60 wt %, about 40 wt % to about 60 wt %, about 50 wt % to about 60 wt %, about 5 wt % to about 50 wt %, about 10 wt % to about 40 wt %, about 10 wt % to about 20 wt %, about 20 wt % to about 30 wt %, or about 20 wt % to about 40 wt % by weight of the interlayer. As another example, the metal may be present in the interlayer 120 in an amount of about 1 wt %, 2 wt %, 3 wt %, 4 wt %, 5 wt %, 6 wt %, 7 wt %, 8 wt %, 9 wt %, 10 wt %, 15 wt %, 20 wt %, 25 wt %, 30 wt %, 35 wt %, 40 wt %, 45 wt %, 50 wt %, 55 wt %, or about 60 wt %.

The metal may have an average particle size (i.e., D50) of about 10 μm or less. For example, the metal may have an average particle size of about 9 μm or less, about 8 μm or less, about 7 μm or less, about 6 μm or less, about 5 μm or less, about 4 μm or less, about 3 μm or less, about 2 μm or less, or about 1 μm or less. Preferably, the metal is in the form of a nanopowder. As used herein, a nanopowder is defined as a powder having an average particle size (i.e., D₅₀) of about 900 nm or less, such as about 500 nm or less.

The interlayer 120 may additionally comprise one or more binders. The binder aids in adhesion of the interlayer 120 to the first current collector 102 and increases the structural integrity of the interlayer 120. Additionally, the binder may enable improved cohesion between like particles in different layers of an electrochemical cell. The binder may also form a flexible matrix when mixed with a solid electrolyte material. In some embodiments, the binder may comprise a fluororesin containing vinylidene fluoride (VdF), hexafluoropropylene (HFP), tetrafluoroethylene (TFE), and derivatives thereof as structural units. In some additional embodiments, the binder may comprise homopolymers such as polyvinylidene fluoride (PVdF), polyhexafluoropropylene (PHFP), and binary copolymers such as copolymers of VdF and HFP such as poly (vinylene difluoride-hexafluoropropylene) copolymer (PVdF-HFP), and the like. In another embodiment, the binder may include a thermoplastic elastomer such as but not limited to styrene-butadiene rubber (SBR), styrene-butadiene-styrene block copolymer (SBS), styrene-isoprene block copolymer (SIS), styrene-ethylene-butylene-styrene block copolymer (SEBS), polyacrylonitrile (PAN), nitrile-butylene rubber (NBR), polybutadiene, polyisoprene, poly(methacrylate) nitrile-butadiene rubber (PMMA-NBR) and the like.

In a further embodiment, the binder may include an acrylic resin such as but not limited to polymethyl(meth)acrylate, polyethyl(meth)acrylate, polyisopropyl(meth)acrylate polyisobutyl(meth)acrylate, polybutyl(meth)acrylate, and the like. In yet another embodiment, the binder may include a polycondensation polymer such as but not limited to polyurea, polyamide paper, polyimide, polyamide-imide (PAI), polyester, and the like. In yet a further embodiment, the binder may include a nitrile rubber such as but not limited to acrylonitrile-butadiene rubber (ABR), polystyrene nitrile-butadiene rubber (PS-NBR), and mixtures thereof.

In a preferred embodiment, the binder includes PVdF, PAI, or a combination thereof. In preferred embodiments where the first interlayer contains a solid electrolyte, the binder includes a styrenic block copolymer. In an exemplary embodiment when the first interlayer contains a solid electrolyte, the binder includes SEBS. In another exemplary embodiment, the binder comprises SEBS and SBS.

In some aspects, the binder may be present in the interlayer 120 in an amount from about 0% to about 50% by weight of the interlayer 120; for example, the binder may be present in the interlayer 120 in an amount from about 0% to about 10%, about 0% to about 20%, about 0% to about 30%, about 0% to about 40%, about 0% to about 50%, about 10% to about 50%, about 20% to about 50%, about 30% to about 50%, about 40% to about 50%, about 10% to about 20%, about 10% to about 30%, about 10% to about 40%, about 20% to about 30%, about 20% to about 40%, or about 30% to about 40% by weight of the interlayer 120. As another example, the binder may be present in the interlayer 120 in an amount of about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, or about 50% by weight of the interlayer 120. In an exemplary embodiment, the binder is present in the interlayer 120 in an amount from about 10% to about 20% by weight of the interlayer 120.

The solid electrolyte material may be present in the interlayer 120 in an amount from about 0% to about 60% by weight of the interlayer 120. For example, the solid electrolyte material may be present in the interlayer 120 in an amount from about 0% to about 10%, about 0% to about 20%, about 0% to about 30%, about 0% to about 40%, about 0% to about 50%, about 0% to about 60%, about 10% to about 60%, about 20% to about 60%, about 30% to about 60%, about 40% to about 60%, about 50% to about 60%, about 10% to about 50%, or about 20% to about 40% by weight of the interlayer 120. In some additional examples, the solid electrolyte material may be present in the interlayer 120 in an amount of about 0%, about 5%, about 10%, about 15%, about 20%, about 25%, about 30%, about 35%, about 40%, about 45%, about 50%, about 55%, or about 60% by weight of the interlayer 120. As yet another example, the solid electrolyte material may be present in the interlayer 120 in an amount of about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, or 60% by weight of the interlayer 120.

The interlayer 120 may have a thickness from about 1 μm to about 20 μm before the interlayer undergoes densification. For example, the interlayer 120 may have a thickness of about 1 μm, about 2 μm, about 3 μm, about 4 μm, about 5 μm, about 6 μm, about 7 μm, about 8 μm, about 9 μm, about 10 μm, about 11 μm, about 12 μm, about 13 μm, about 14 μm, about 15 μm, about 16 μm, about 17 μm, about 18 μm, about 19 μm, or about 20 μm. In some aspects, the interlayer 120 may have a thickness from about 1 μm to about 2 μm, about 1 μm to about 4 μm, about 1 μm to about 6 μm, about 1 μm to about 8 μm, about 1 μm to about 10 μm, about 1 μm to about 12 μm, about 1 μm to about 14 μm, about 1 μm to about 16 μm, about 1 μm to about 18 μm, about 1 μm to about 20 μm, about 2 μm to about 20 μm, about 4 μm to about 20 μm, about 6 μm to about 20 μm, about 8 μm to about 20 μm, about 10 μm to about 20 μm, about 12 μm to about 20 μm, about 14 μm to about 20 μm, about 16 μm to about 20 μm, about 18 μm to about 20 μm, or about 5 μm to about 15 μm before the interlayer undergoes densification.

The interlayer 120 may have a porosity from about 20% to about 50%. For example, the first interlayer 120 may have a porosity from about 20% to about 25%, about 20% to about 30%, about 20% to about 35%, about 20% to about 40%, about 20% to about 45%, about 20% to about 50%, about 25% to about 50%, about 30% to about 50%, about 35% to about 50%, about 40% to about 50%, about 45% to about 50%, about 25% to about 45%, or about 30% to about 40%.

The interlayer 120 may have a density from about 0.5 g/cm³ to about 2 g/cm³. For example, the interlayer 120 may have a density from about 0.5 g/cm³ to about 1 g/cm³, about 0.5 g/cm³ to about 1.5 g/cm³, about 0.5 g/cm³ to about 2 g/cm³, about 1 g/cm³ to about 1.5 g/cm³, about 1 g/cm³ to about 2 g/cm³, or about 1.5 g/cm³ to about 2 g/cm³. As another example, the interlayer 120 may have a density of about 0.5 g/cm³, 0.6 g/cm³, 0.7 g/cm³, 0.8 g/cm³, 0.9 g/cm³, 1 g/cm³, 1.1 g/cm³, 1.2 g/cm³, 1.3 g/cm³, 1.4 g/cm³, 1.5 g/cm³, 1.6 g/cm³, 1.7 g/cm³, 1.8 g/cm³, 1.9 g/cm³, or about 2 g/cm³.

The separator layer 130 is in operable contact with the interlayer 120 and may be in physical contact with the interlayer 120. The separator layer 130 (also referred to herein as the “electrolyte layer”) may include one or more solid electrolyte materials. The one or more solid electrolyte materials may comprise an oxide, oxysulfide, sulfide, halide, nitride, or any other solid electrolyte material known in the art. In some preferred embodiments, the one or more solid electrolyte materials may comprise a sulfide solid electrolyte material. In some aspects, the one or more sulfide solid electrolyte material may comprise one or more material combinations such as Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—S—SiS₂—LiCl, Li₂S—S—SiS₂—B₂S₃—LiI, Li₂S—S—SiS₂—P₂S₅—LiI, Li₂S—B₂S₃, Li₂S—P₂S₅—ZₘSₙ (where m and n are positive numbers, and Z is Ge, Zn or Ga), Li₂S—GeS₂, Li₂S—S—SiS₂—Li₃PO₄, and Li₂S—S—SiS₂-LiₓMO_{y} (where x and y are positive numbers, and M is P, Si, Ge, B, Al, Ga or In). In some embodiments, one or more of the solid electrolyte materials may include Li₃PS₄, Li₄P₂S₆, Li₂P₃S₁₁, Li₁₀GeP₂S₁₂, Li₁₀SnP₂S₁₂. In another embodiment, one or more of the solid electrolyte materials may include an argyrodite electrolyte such as Li₆PS₅Cl, Li₆PS₅Br, Li₆PS₅I or expressed by the formula Li_{7-y}PS_{6-y}X_{y}, where “X” represents at least one halogen and/or at least one pseudo-halogen, where 0<y≤2.0, and where the halogen may be one or more of F, Cl, Br, I, and the pseudo-halogen may be one or more of N, NH, NH₂, NO, NO₂, BF₄, BH₄, AlH₄, CN, and SCN. In another embodiment, one or more of the solid electrolyte materials may be expressed by the formula Li_{8-y-z}P₂S_{9-y-z}X_{y}W_{z} (where “X” and “W” represents at least one halogen and/or at least one pseudo-halogen and where 0≤y≤1 and 0≤z≤1) and where the halogen may be one or more of F, Cl, Br, I, and the pseudo-halogen may be one or more of N, NH, NH₂, NO, NO₂, BF₄, BH₄, AlH₄, CN, and SCN. In additional embodiments, the solid electrolyte material may be a halide electrolyte. Halide solid electrolytes may have the structure Li-M-X, M is a metal element, and X is a halogen. These can be expressed by the generic formula Li_{α}M⁴⁺_{β}N³⁺_{(1-β)}X_{Ω}Y_{(6-Ω)}, where: 0≤β≤1; 0≤Ω≤6; α=6−[(β*4)+(1−β)*3]; X and Y may each independently be a halogen such as F, Cl, Br, or I; M is an element with an oxidation state of 4+ such as Ti, Zr, Hf, and Rf; and N is an element an oxidation state of 3+ such as Ga, In, and Tl, Sc, Y, Fe, Ru, Os, Er. Examples of halide electrolytes include Li₂ZrCl₆, Li₃InCl₆, Li_{2.25}Hf_{0.75}Fe_{0.25}Cl₄Br₂.

The solid electrolyte may be present in the separator layer 130 in an amount from about 50% to about 99% by weight of the separator layer 130. For example, the solid electrolyte may be present in the separator layer 130 in an amount from about 50% to about 60%, about 50% to about 70%, about 50% to about 80%, about 50% to about 90%, about 50% to about 95%, about 50% to about 99%, about 60% to about 99%, about 70% to about 99%, about 80% to about 99%, about 90% to about 99%, or about 95% to about 99% by weight of the separator layer.

The separator layer 130 may additionally comprise one or more binders. In some embodiments, the binder may comprise fluororesin containing vinylidene fluoride (VdF), hexafluoropropylene (HFP), tetrafluoroethylene (TFE), and derivatives thereof as structural units. In some additional embodiments, the binder may comprise homopolymers such as polyvinylidene fluoride (PVdF), polyhexafluoropropylene (PHFP), and binary copolymers such as copolymers of VdF and HFP such as poly (vinylene difluoride-hexafluoropropylene) copolymer (PVdF-HFP), and the like. In another embodiment, the binder may include a thermoplastic elastomer such as but not limited to styrene-butadiene rubber (SBR), styrene-butadiene-styrene block copolymer (SBS), styrene-isoprene block copolymer (SIS), styrene-ethylene-butylene-styrene block copolymer (SEBS), polyacrylonitrile (PAN), nitrile-butylene rubber (NBR), polybutadiene, polyisoprene, poly (methacrylate) nitrile-butadiene rubber (PMMA-NBR) and the like.

In a further embodiment, the binder may include an acrylic resin such as but not limited to polymethyl(meth)acrylate, polyethyl(meth)acrylate, polyisopropyl(meth)acrylate polyisobutyl(meth)acrylate, polybutyl(meth)acrylate, and the like. In yet another embodiment, the binder may include a polycondensation polymer such as but not limited to polyurea, polyamide paper, polyimide, polyamide-imide (PAI), polyester, and the like. In yet a further embodiment, the binder may include a nitrile rubber such as but not limited to acrylonitrile-butadiene rubber (ABR), polystyrene nitrile-butadiene rubber (PS-NBR), and mixtures thereof.

In preferred embodiments, the binder is a styrenic block copolymer. In an exemplary embodiment, the binder is SEBS. In another exemplary embodiment, the binder comprises SEBS and SBS.

In some aspects, the binder may be present in the separator layer 130 in an amount from about 0% to about 30% by weight of the separator layer 130; for example, the binder may be present in the separator layer 130 in an amount of about 0% to about 5%, about 0% to about 10%, about 0% to about 15%, about 0% to about 20%, about 0% to about 25%, about 0% to about 30%, about 5% to about 30%, about 10% to about 30%, about 15% to about 30%, about 20% to about 30%, about 25% to about 30%, about 5% to about 10%, about 5% to about 15%, about 5% to about 20%, about 10% to about 15%, or about 10% to about 20%. As another example, the binder may be present in the separator layer 130 in an amount of about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, or about 30% by weight of the separator layer 130. In another aspect, the binder may be present in the separator layer in an amount of no more than 5%, no more than 10%, no more than 15%, no more than 20%, no more than 25%, or no more than 30%. In an exemplary embodiment, the binder is present in the separator layer 130 in an amount from about 4% to about 5% by weight.

The cathode layer 140 is in operable contact with the separator layer 130 and may be in physical contact with the separator layer 130. The cathode layer may include a cathode active material such as nickel-manganese-cobalt (“NMC”) which may be expressed as Li(NiₐCo_{b}Mn_{c})O₂ (0<a<1, 0<b<1, 0<c<1, a+b+c=1) or, for example, NMC 111 (LiNi_{0.33}Mn_{0.33}Co_{0.33}O₂), NMC 433 (LiNi_{0.4}Mn_{0.3}Co_{0.3}O₂), NMC 532 (LiNi_{0.5}Mn_{0.3}Co_{0.2}O₂), NMC 622 (LiNi_{0.6}Mn_{0.2}Co_{0.2}O₂), NMC 811 (LiNi_{0.8}Mn_{0.1}Co_{0.1}O₂) or a combination thereof. In another embodiment, the cathode active material may comprise a coated or uncoated metal oxide, such as but not limited to V₂O₅, V₆O₁₃, MoO₃, LiCoO₂, LiNiO₂, LiMnO₂, LiMn₂O₄, LiNi_{1-Y}CO_{Y}O₂, LiCO_{1-Y}Mn_{Y}O₂, LiNi_{1-Y}Mn_{Y}O₂ (0≤Y≤1), Li(NiₐCO_{b}Mn_{c})O₄ (0<a<2, 0<b<2, 0<c<2, a+b+c=2), LiMn_{2-Z}Ni_{Z}O₄, LiMn_{2-Z}Co_{Z}O₄ (0<Z<2), LiCoPO₄, LifePO₄, CuO, Li(NiₐCo_{b}Al_{c})O₂ (0<a<1, 0<b<1, 0<<<1, a+b+c=1) or a combination thereof. In yet another embodiment, the cathode active material may comprise one or more of a coated or uncoated metal sulfide such as but not limited to titanium sulfide (TiS₂), molybdenum sulfide (MoS₂), iron sulfide (FeS, FeS₂), copper sulfide (CuS), and nickel sulfide (Ni₃S₂) or combination thereof. In still further embodiments, the cathode active material may comprise elemental sulfur(S). In additional embodiments, the cathode active material may comprise a fluoride, such as but not limited to lithium fluoride (LiF), sodium fluoride (NaF), calcium fluoride (CaF₂), magnesium fluoride (MgF₂), nickel (II) fluoride (NiF₂), iron (III) fluoride (FeF₃), vanadium (III) fluoride (VF₃), cobalt (III) fluoride (CoF₃), chromium (III) fluoride (CrF₃), manganese (III) fluoride (MnF₃), aluminum fluoride (AlF₃), and zirconium (IV) fluoride (ZrF₄), or combinations thereof.

The cathode active material may be present in the cathode layer 140 in an amount of up to 99% by weight of the cathode layer. For example, the cathode active material may be present in the cathode layer 140 in an amount from about 1% to about 20%, about 1% to about 40%, about 1% to about 60%, about 1% to about 80%, about 1% to about 99%, about 20% to about 99%, about 40% to about 99%, about 60% to about 99%, about 80% to about 99%, about 20% to about 80%, or about 40% to about 60% by weight of the cathode layer. In another aspect, the cathode active material may be present in the cathode layer 140 in an amount of no more than 10%, no more than 20%, no more than 30%, no more than 40%, no more than 50%, no more than 60%, no more than 70%, no more than 80%, no more than 90%, or no more than 99% by weight of the cathode layer. As another example the cathode active material may be present in the cathode layer 140 in an amount of about 1%, 5%, 10%, 15%, 20%, 25%, 30%, 35%, 40%, 45%, 50%, 55%, 60%, 65%, 70%, 75%, 80%, 85%, 90%, 95%, or about 99% by weight of the cathode layer.

The cathode layer 140 may further comprise one or more conductive additives. The conductive additives may include metal powders, fibers, filaments, or any other material known to conduct electrons. In some aspects, the one or more conductive additives may include one or more conductive carbon materials such as carbon fiber, graphite, graphene, carbon black, conductive carbon, amorphous carbon, vapor grown carbon fiber (VGCF), activated carbon, and carbon nanotubes. In some aspects, the conductive additive may be present in the cathode layer 140 in an amount from about 0% to about 20% by weight of the cathode layer 140. In some aspects, the conductive additive may be present in the cathode layer 140 in an amount from about 0% to about 5%, about 0% to about 10%, about 0% to about 15%, about 0% to about 20%, about 5% to about 20%, about 10% to about 20%, about 15% to about 20%, or about 5% to about 15% by weight of the cathode layer 140. In another aspect, the conductive additive may be present in the cathode layer 140 in an amount of no more than 5%, no more than 10%, no more than 15%, or no more than 20% by weight of the cathode layer.

The cathode layer 140 may further comprise one or more solid electrolyte materials. The one or more solid electrolyte material may comprise an oxide, oxysulfide, sulfide, halide, nitride, or any other solid electrolyte material known in the art. In some preferred embodiments, the one or more solid electrolyte materials may comprise a sulfide solid electrolyte material. In some embodiments, the solid electrolyte material may comprise one or more material combinations such as Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—S—SiS₂—LiCl, Li₂S—S—SiS₂—B₂S₃—LiI, Li₂S—S—SiS₂—P₂S₅—LiI, Li₂S B₂S₃, Li₂S—P₂S₅—ZₘSₙ (where m and n are positive numbers, and Z is Ge, Zn or Ga), Li₂S GeS₂, Li₂S—S—SiS₂—Li₃PO₄, and Li₂S—S—SiS₂-LiₓMO_{y} (where x and y are positive numbers, and M is P, Si, Ge, B, Al, Ga or In). In another embodiment, the solid electrolyte material may include a Li₃PS₄, Li₄P₂S₆, Li₇P₃S₁₁, Li₁₀GeP₂S₁₂, Li₁₀SnP₂S₁₂. In a further embodiment, the solid electrolyte material may include an argyrodite electrolyte, such as one or more of a Li₆PS₅Cl, Li₆PS₅Br, Li₆PS₅I or expressed by the formula Li_{7-y}PS_{6-y}X_{y} where “X” represents at least one halogen and/or at least one pseudo-halogen, where 0<y≤2.0, and where the at least one halogen may be one or more of F, Cl, Br, I, and the at least one pseudo-halogen may be one or more of N, NH, NH₂, NO, NO₂, BF₄, BH₄, AlH₄, CN, and SCN. In yet another embodiment, the solid electrolyte material be expressed by the formula Li_{8-y-z}P₂S_{9-y-z}X_{y}W_{z} (where “X” and “W” each independently represents at least one halogen elements and or pseudo-halogen and where 0≤y≤1 and 0≤z≤1) and where a halogen may be one or more of F, Cl, Br, I, and a pseudo-halogen may be one or N, NH, NH₂, NO, NO₂, BF₄, BH₄, AlH₄, CN, and SCN. In additional embodiments, the solid electrolyte material may include a halide electrolyte. Halide solid electrolytes may have the structure Li-M-X, M is a metal element, and X is a halogen. These can be expressed by the generic formula Li_{α}M⁴⁺_{β}N³⁺_{(1-β)}X_{Ω}Y_{(6-Ω)}, where: 0≤β≤1; 0≤Ω≤6; α=6−[(β*4)+(1−β)*3]; X and Y are a halogen such as F, Cl, Br, I; M is an element with an oxidation state of 4+ such as Ti, Zr, Hf, and Rf; and N is an element an oxidation state of 3+ such as Ga, In, and Tl, Sc, Y, Fe, Ru, Os, Er. Examples of halide electrolytes include Li₂ZrCl₆, Li₃InCl₆, and Li_{2.25}Hf_{0.75}Fe_{0.25}Cl₄Br₂.

In some aspects, the solid electrolyte may be present in the cathode layer 140 in an amount from about 1% to about 30% by weight of the cathode layer. For example, the solid state electrolyte may be present in the cathode layer in an amount from about 1% to about 5%, about 1% to about 10%, about 1% to about 15%, about 1% to about 20%, about 1% to about 25%, about 1% to about 30%, about 5% to about 30%, about 10% to about 30%, about 15% to about 30%, about 20% to about 30%, or about 25% to about 30% by weight of the cathode layer 140. As another example, the solid electrolyte may be present in the cathode layer 140 in an amount of about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, or about 30% by weight of the cathode layer 140.

The cathode layer 140 may further comprise a binder. In some embodiments, the binder may include fluororesin containing vinylidene fluoride (VdF), hexafluoropropylene (HFP), tetrafluoroethylene (TFE), and derivatives thereof as structural units. Specific examples thereof include homopolymers such as polyvinylidene fluoride (PVdF), polyhexafluoropropylene (PHFP), and polytetrafluoroethylene (PTFE), and binary copolymers such as copolymers of VdF and HFP such as poly (vinylene difluoride-hexafluoropropylene) copolymer (PVdF-HFP), and the like. In another embodiment, the binder may be one or more of a thermoplastic elastomer such as but not limited to styrene-butadiene rubber (SBR), styrene-butadiene-styrene copolymer (SBS), styrene-isoprene block copolymer (SIS), styrene-ethylene-butylene-styrene (SEBS), polyacrylonitrile (PAN), nitrile-butylene rubber (NBR), polybutadiene, polyisoprene, poly (methacrylate) nitrile-butadiene rubber (PMMA-NBR) and the like. In a further embodiment, the binder may include an acrylic resin such as but not limited to polymethyl(meth)acrylate, polyethyl(meth)acrylate, polyisopropyl(meth)acrylate polyisobutyl(meth)acrylate, polybutyl(meth)acrylate, and the like. In yet another embodiment, the binder may include a polycondensation polymer such as but not limited to polyurea, polyamide paper, polyimide, polyester, and the like. In yet a further embodiment, the binder may include a nitrile rubber such as but not limited to acrylonitrile-butadiene rubber (ABR), polystyrene nitrile-butadiene rubber (PS-NBR), and mixtures thereof.

In some aspects, the binder may be present in the cathode layer 140 in an amount from about 0% to about 20% by weight of the cathode layer 140. For example, the binder may be present in the cathode layer in an amount from about 0% to about 5%, about 0% to about 10%, about 0% to about 15%, about 0% to about 20%, about 5% to about 20%, about 10% to about 20%, about 15% to about 20%, or about 5% to about 15% by weight of the cathode layer 140. In some additional aspects, the binder may be present in the cathode layer 140 in an amount of no more than 5%, no more than 10%, no more than 15%, or no more than 20% by weight of the cathode layer 140.

In some embodiments, the cathode layer 140 may have a thickness from about 10 μm to about 1000 μm. In some aspects, the electrolyte layer may have a thickness from about 10 μm to about 200 μm, about 10 μm to about 400 μm, about 10 μm to about 600 μm, about 10 μm to about 800 μm, about 10 μm to about 1000 μm, about 200 μm to about 1000 μm, about 400 μm to about 1000 μm, about 600 μm to about 1000 μm, about 800 μm to about 1000 μm, about 200 μm to about 800 μm, or about 400 μm to about 600 μm. In some additional aspects, the electrolyte layer may have a thickness of about 10 μm, 50 μm, 100 μm, 150 μm, 200 μm, 250 μm, 300 μm, 350 μm, 400 μm, 450 μm, 500 μm, 550 μm, 600 μm, 650 μm, 700 μm, 750 μm, 800 μm, 850 μm, 900 μm, 950 μm, or about 1000 μm.

The second current collector layer 112 is in operable contact with the cathode layer 140 and may be in physical contact with the cathode layer 140. The second current collector 112 may comprise aluminum, copper, stainless steel, titanium, nickel, or a combination thereof. The second current collector 112 may be coated with a layer of carbon, wherein the layer of carbon contacts the cathode layer. The second current collector 112 may have a thickness from about 1 μm to about 100 μm. For example, the second current collector 112 may have a thickness from about 1 μm to about 20 μm, about 1 μm to about 40 μm, about 1 μm to about 60 μm, about 1 μm to about 80 μm, about 1 μm to about 100 μm, about 20 μm to about 100 μm, about 40 μm to about 100 μm, about 60 μm to about 100 μm, about 80 μm to about 100 μm, about 20 μm to about 80 μm, or about 40 μm to about 60 μm.

When the interlayer 120 is split, the top layer 122 may have a thickness from about 1 μm to about 20 μm, and the bottom layer 124 may have a thickness from about 1 μm to about 20 μm.

For example, the top layer 122 may have a thickness from about from about 1 μm to about 2 μm, about 1 μm to about 4 μm, about 1 μm to about 6 μm, about 1 μm to about 8 μm, about 1 μm to about 10 μm, about 1 μm to about 12 μm, about 1 μm to about 14 μm, about 1 μm to about 16 μm, about 1 μm to about 18 μm, about 1 μm to about 20 μm, about 2 μm to about 20 μm, about 4 μm to about 20 μm, about 6 μm to about 20 μm, about 8 μm to about 20 μm, about 10 μm to about 20 μm, about 12 μm to about 20 μm, about 14 μm to about 20 μm, about 16 μm to about 20 μm, about 18 μm to about 20 μm, or about 5 μm to about 15 μm. As another example, the top layer 122 may have a thickness of about 1 μm, 2 μm, 3 μm, 4 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, or about 20 μm.

Likewise, the bottom layer 124 may have a thickness from about 1 μm to about 2 μm, about 1 μm to about 4 μm, about 1 μm to about 6 μm, about 1 μm to about 8 μm, about 1 μm to about 10 μm, about 1 μm to about 12 μm, about 1 μm to about 14 μm, about 1 μm to about 16 μm, about 1 μm to about 18 μm, about 1 μm to about 20 μm, about 2 μm to about 20 μm, about 4 μm to about 20 μm, about 6 μm to about 20 μm, about 8 μm to about 20 μm, about 10 μm to about 20 μm, about 12 μm to about 20 μm, about 14 μm to about 20 μm, about 16 μm to about 20 μm, about 18 μm to about 20 μm, or about 5 μm to about 15 μm. As another example, the bottom layer 124 may have a thickness of about 1 μm, 2 μm, 3 μm, 4 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, or about 20 μm.

The lithium metal layer 150 may comprise or consist of lithium metal. The lithium metal layer 150 may further include metal selected from the group consisting of silver, zinc, aluminum, magnesium, tin, antimony, silicon, and any combination thereof. One of these metals may form alloys with the lithium and one or more other metals included in the interlayer.

Further provided herein is a method of making an electrochemical cell. The electrochemical cell may be any electrochemical cell described above. The method comprises coating an interlayer composition onto a first current collector, thereby forming a first portion of the electrochemical cell. The method further comprises coating a cathode layer composition onto a second current collector, and then coating a separator layer composition onto the cathode layer composition, thereby forming a second portion of the electrochemical cell. The method may further comprise laminating the first portion of the electrochemical cell with the second portion of the electrochemical cell. The lamination may occur such that the interlayer of the first portion of the electrochemical cell is in operable contact with the separator layer of the second portion of the electrochemical cell. The coating may be accomplished by various coating and casting methods known in the art, such as tape casting.

In an alternative embodiment, the method may comprise coating any of the layers of the electrochemical cell onto a carrier foil, and then transferring the coated layer from the carrier foil. For example, the method may comprise coating an interlayer composition onto a carrier foil and transferring the first interlayer composition from the carrier foil to a first current collector layer via lamination and forming a first portion of the electrochemical cell. The first portion of the electrochemical cell may then be laminated with a second portion of the electrochemical cell.

In another embodiment, the method comprises coating an interlayer onto a current collector, wherein the interlayer comprises a binder; coating a separator layer onto the interlayer before the interlayer has dried, wherein the separator layer does not comprise a binder when it is coated; and drying the separator layer and the interlayer. As the interlayer and the separator dry, the evaporating solvent pulls the binder upward from the interlayer into the separator layer through advection. Therefore, the dried separator layer comprises the binder.

The interlayer may be coated onto the first current collector at a loading from about 0.1 mg/cm² to about 2 mg/cm². For example, the interlayer may be coated onto the first current collector at a loading from about 0.1 mg/cm² to about 0.25 mg/cm², about 0.1 mg/cm² to about 0.5 mg/cm², about 0.1 mg/cm² to about 0.75 mg/cm², about 0.1 mg/cm² to about 1 mg/cm², about 0.1 mg/cm² to about 1.25 mg/cm², about 0.1 mg/cm² to about 1.5 mg/cm², about 0.1 mg/cm² to about 1.75 mg/cm², about 0.1 mg/cm² to about 2 mg/cm², about 0.25 mg/cm² to about 2 mg/cm², about 0.75 mg/cm² to about 2 mg/cm², about 1 mg/cm² to about 2 mg/cm², about 1.25 mg/cm² to about 2 mg/cm², about 1.5 mg/cm² to about 2 mg/cm², about 1.75 mg/cm² to about 2 mg/cm², about 0.25 mg/cm² to about 1.75 mg/cm², about 0.5 mg/cm² to about 1.5 mg/cm², or about 0.75 mg/cm² to about 1.25 mg/cm². As another example, the interlayer may be coated onto the first current collector at a loading of about 0.1 mg/cm², 0.2 mg/cm², 0.3 mg/cm², 0.4 mg/cm², 0.5 mg/cm², 0.6 mg/cm², 0.7 mg/cm², 0.8 mg/cm², 0.9 mg/cm², 1 mg/cm², 1.1 mg/cm², 1.2 mg/cm², 1.3 mg/cm², 1.4 mg/cm², 1.5 mg/cm², 1.6 mg/cm², 1.7 mg/cm², 1.8 mg/cm², 1.9 mg/cm², or about 2 mg/cm².

Coating the various layers may be accomplished by forming a slurry. The slurry is created by combining the materials used in each respective layer to form a composite mixture, and then adding a solvent to the composite mixture to form a slurry. As such, the interlayer slurry may comprise a metal, a mixture of carbon materials, and/or a binder. The separator slurry may comprise a solid electrolyte material and a binder. The cathode slurry may comprise a cathode active material, a solid electrolyte material, a binder, and/or a conductive additive.

The solvent may be selected from but is not limited to one of the following: aprotic hydrocarbons, esters, ethers or nitriles. In another aspect, the aprotic hydrocarbons may be selected from but are not limited to one of the following: xylenes, toluene, benzene, methyl benzene, hexanes, heptane, octane, alkanes, isoparaffinic hydrocarbons or a combination thereof. In another aspect, the esters may be selected from but are not limited to one of the following: butyl butyrate, isobutyl isobutyrate methyl propionate, ethyl propionate, propyl propionate, butyl propionate, methyl acetate, ethyl acetate, propyl acetate, butyl acetate or a combination thereof. In another aspect, the ethers may be selected from but are not limited to one of the following: diethyl ether, dibutyl ether, benzyl ether or a combination thereof. In another aspect, the nitriles may be selected from but are not limited to one of the following: acetonitrile, propionitrile, butyronitrile, pyrrolidine or a combination thereof.

Substantially removing the one or more solvent may be accomplished by methods known in the art, including by drying or by adjusting ambient temperature or pressure to induce or accelerate evaporation of the one or more solvent. As used herein “substantially removing the one or more solvent” means that the final composition comprises essentially no solvent (i.e., less than 1% by weight of the one or more solvents). In preferred embodiments, the final composition comprises less than 0.1% by weight of the one or more solvents. In more preferred embodiments, the final composition comprises no solvent.

In some embodiments, the method may further include pressing one or more of the layers of the electrochemical cell. The pressing may include pressing a single layer or may include pressing two or more of the layers. The pressing may be accomplished using methods known in the art, such as laminating, calendaring or machine pressing.

The pressing may be accomplished at a pressure from about 100 psi to about 500,000 psi. For example, the pressing may be accomplished from about 100 psi to about 500 psi, about 500 psi to about 1,000 psi, about 1,000 psi, about 1,000 psi to about 5,000 psi, about 5,000 psi to about 10,000 psi, about 10,000 psi to about 50,000 psi, about 50,000 psi to about 100,000 psi, about 100 psi to about 1,000 psi, about 100 psi to about 5,000 psi, about 100 psi to about 10,000 psi, about 100 psi to about 50,000 psi, about 100 psi to about 100,000 psi, about 500 psi to about 100,000 psi, about 1,000 psi to about 100,000 psi, about 5,000 psi to about 100,000 psi, about 10,000 psi to about 100,000 psi, or about 50,000 psi to about 100,000 psi.

Further provided herein is a method of producing layers for use in a solid-state electrochemical cell. The method comprises producing a first layer and a second layer in slurry form, each layer comprising one or more solvents; coating the first layer onto a carrier foil or a current collector; coating the second layer onto the carrier foil or current collector in close proximity to the first layer; increasing a surface-to-surface contact of the first layer and the second layer; and substantially removing the one or more solvents. Coating may be accomplished by tape casting. Systems and methods for tape casting are generally known in the art. Each of the layers may be an interlayer or a separator layer as described herein. In some embodiments, the first layer is an interlayer and the second layer is a separator layer.

When the first layer is an interlayer, the carrier foil may comprise copper, nickel, stainless steel, lithium alloys, or carbon fiber. In some aspects, the carrier foil may be coated with carbon.

When the first layer is a cathode layer, the carrier foil may comprise aluminum, copper, or stainless steel.

The one or more solvents may be any of the solvents described herein. The one or more solvents may comprise a dissolved binder, which may be any binder described herein.

Substantially removing the one or more solvent may be accomplished by methods known in the art, including by drying or by adjusting ambient temperature or pressure to induce or accelerate evaporation of the one or more solvent. The method may further comprise generating a capillary effect through the first layer and the second layer. The capillary effect may be generated by evaporation of the one or more solvents. In order to generate the capillary effect, the binders must be soluble in the solvent that is used. If the binder is not dissolved, it will be unable to move within the layers. Additionally, the layers must have sufficient porosity to allow the binder to travel during the drying process.

In embodiments where the layers are dried, the dried interlayers may be incorporated into an electrochemical cell or battery. In some embodiments, the battery may comprise layers, wherein each layer has at least one solid-to-solid interface with another layer of the battery. For example, a battery may include a solid anode layer, a solid separator layer, and a solid cathode layer, each layer having a solid-to-solid interface between each layer.

The surface-to-surface contact of the first and second layer may be increased by pressing methods described herein and known in the art.

Unless defined otherwise, all technical and scientific terms used herein have the same meaning as commonly understood by those of ordinary skill in the art to which the disclosure belongs. Although any methods and materials similar or equivalent to those described herein can be used in the practice or testing of the subject matter of the present disclosure, preferred methods and materials are described. For the purposes of the present disclosure, the following terms are defined below.

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range or the characteristics being described.

The term “about” will be understood by persons of ordinary skill in the art and will vary to some extent on the context in which it is used. As used herein when referring to a measurable value such as an amount, a temporal duration, and the like, the term “about” is meant to encompass variations of ±10%, including ±5%, ±1%, and ±0.1% from the specified value, as such variations are appropriate to perform the disclosed methods.

In this disclosure, “comprises,” “comprising,” “containing,” and “having” and the like can have the meaning ascribed to them in U.S. Patent Law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the composition's nature or characteristics would be permissible if present under the “consisting essentially of” language, even though not expressly recited in a list of items following such terminology. In this specification when using an open-ended term, like “comprising” or “including,” it is understood that direct support should be afforded also to “consisting essentially of” language as well as “consisting of” language as if stated explicitly and vice versa.

### EXAMPLES

### Example 1

A composite with a weight ratio of 1:1:3 of a silver nanopowder, a silicon nanopowder, carbon black, and graphite were mixed together. This composite was mixed with a binder at a 9:1 weight ratio of composite to SEBS. This binder containing composite was mixed with a hydrocarbon-based solvent to form a uniform mixture of material. This uniform mixture was then coated onto a carbon-coated copper foil. The mixture was then dried to form the interlayer of Example 1. This interlayer was then assembled into a solid-state electrochemical cell containing a cathode current collector, a cathode layer, a separator layer, and the interlayer of Example 1 which functioned as an anode and anode current collector, respectively.

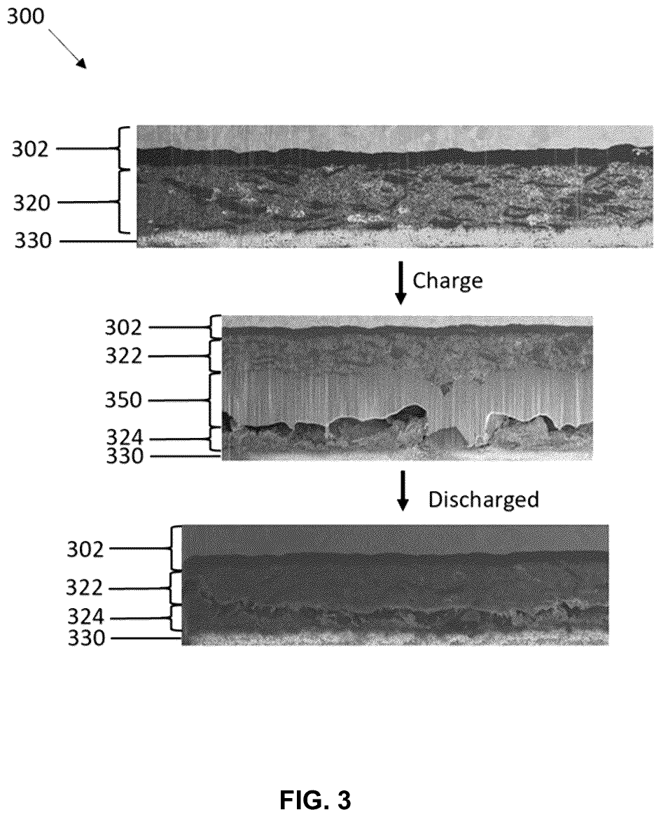

Turning to FIG. 3, the top image shows a section of an as-built electrochemical cell containing the interlayer of Example 1. The top image shows the carbon coated copper current collector 302, the interlayer 320, and the separator layer 330. When the electrochemical cell was fully charged, the interlayer 320 split as lithium ions plated inside the interlayer 320 forming a dense layer of lithium metal 350. The interlayer 320 split into two layers, a top layer 322 and a bottom layer 324, which is shown in the middle image of FIG. 3. During discharge, the lithium metal was converted back into lithium ions and moved back to the cathode (not shown), and the top layer 322 and the bottom layer 324 came back together as shown in the bottom image of FIG. 3.

What is claimed is:

1. An electrochemical cell comprising:
a first current collector layer;
an interlayer comprising a mixture of carbon materials, a metal, and a binder;
a separator layer, wherein the interlayer is positioned between the first current collector layer and the separator layer;
a cathode layer; and
a second current collector layer.

2. The electrochemical cell of claim 1, wherein the metal is selected from the group consisting of silver, zinc, aluminum, magnesium, tin, antimony, silicon, and any combination thereof.

3. The electrochemical cell of claim 1, wherein the metal has an average particle size of less than about 10 μm.

4. The electrochemical cell of claim 2, wherein the metal comprises silicon.

5. The electrochemical cell of claim 1, wherein the metal has a concentration in the interlayer from about 1 wt % to about 50 wt %.

6. The electrochemical cell of claim 4, wherein the silicon has a concentration in the interlayer from about 5 wt % to about 50 wt %.

7. The electrochemical cell of claim 1, wherein the mixture of carbon materials comprises graphite and carbon black.

8. The electrochemical cell of claim 1, wherein the interlayer is coated at a loading from about 0.1 and about 2 mg/cm².

9. The electrochemical cell of claim 1, wherein the interlayer has a thickness from about 2 μm to about 20 μm.

10. The electrochemical cell of claim 1, wherein the interlayer has a density from about 0.5 g/cm³ to about 2 g/cm³.

11. The electrochemical cell of claim 1, wherein the interlayer has a porosity from about 10% to about 50%.

12. An electrochemical cell comprising:
a first current collector layer;
a top interlayer comprising a mixture of carbon materials, a metal, and a binder;
a lithium metal layer;
a bottom interlayer comprising a mixture of carbon materials, a metal, and a binder, wherein the lithium metal layer is disposed between the top interlayer and the bottom interlayer;
a separator layer;
a cathode layer; and
a second current collector layer.

13. The electrochemical cell of claim 12, wherein the lithium metal layer consists of lithium metal.

14. The electrochemical cell of claim 12, wherein the lithium metal layer comprises lithium metal and a metal selected from the group consisting of silver, zinc, aluminum, magnesium, tin, antimony, silicon, and any combination thereof.

15. The electrochemical cell of claim 12, wherein the metal of the top layer and the bottom layer comprises silicon.

16. The electrochemical cell of claim 12, wherein the metal of the top layer has a concentration in the top layer from about 1 wt % to about 50 wt %.

17. The electrochemical cell of claim 16, wherein the silicon has a concentration in the interlayer from about 5 wt % to about 50 wt %.

18. The electrochemical cell of claim 12, wherein the mixture of carbon materials comprises graphite and carbon black.

19. The electrochemical cell of claim 12, wherein the metal of the top layer and the metal of the bottom layer are the same.

20. A method for making an electrochemical cell comprising:
coating an interlayer composition onto a first current collector, thereby forming a first portion of the electrochemical cell;
coating a cathode layer composition onto a second current collector;
coating a separator layer composition onto the cathode layer composition, thereby forming a second portion of the electrochemical cell; and
laminating the first portion of the electrochemical cell with the second portion of the electrochemical cell.
